(19) United States
(12) Patent Application Publication
(10) Pub. No.: US 2026/0043158 A1
(43) Pub. Date: Feb. 12, 2026

(54) ELECTROLYTIC CELL AND ANION-EXCHANGE CONDUCTIVE HOLLOW FIBER TUBE MATRIX THEREOF

(71) Applicant: BLADE HYDROGEN GREEN TECHNOLOGY CO., LTD., TAINAN CITY (TW)

(72) Inventors: BO-CONG GONG, TAINAN CITY (TW); CHUN-HAN LI, TAINAN CITY (TW); MING-HSIEN LIN, TAINAN CITY (TW)

(21) Appl. No.: 19/276,131

(22) Filed: Jul. 22, 2025

(30) Foreign Application Priority Data
Aug. 8, 2024 (TW) 113129813

(51) Int. Cl. C25B 13/02; B01J 35/39; B01J 47/127; C01B 3/04; C25B 1/04; C25B 9/23; C25B 11/046; C25B 13/08

(52) U.S. Cl. CPC C25B 13/02; B01J 35/39; B01J 47/127; C01B 3/042; C25B 1/04; C25B 9/23; C25B 11/046; C25B 13/08

(57) ABSTRACT

An electrolytic cell and an anion-exchange conductive hollow fiber tube matrix thereof are disclosed. The anion-exchange conductive hollow fiber tube matrix includes a plurality of conductive hollow fiber tubes arranged adjacent to each other in a matrix. The conductive hollow fiber tubes each have a diffusion surface and two opposite ends defined as an inlet and an outlet. An anode and a cathode of the electrolytic cell are disposed adjacent to the diffusion surface. Water in an electrolysis tank flows into the conductive hollow fiber tubes from the inlet, water molecules enter the cathode from the diffusion surface and decompose to produce hydrogen and hydroxide ions, the hydrogen is discharged from the cathode, the hydroxide ions return to the conductive hollow fiber tubes from the diffusion surface and then enter the anode from the diffusion surface to produce oxygen, the oxygen is discharged from a surface of the anode.

### FIELD OF THE INVENTION

The present invention relates to an electrolytic cell and an anion-exchange conductive hollow fiber tube matrix thereof, and more particularly, to a matrix membrane composed of conductive hollow fiber tubes as an ion exchange interface between the anode and the cathode of the electrolytic cell. Water or electrolyte can be directly guided into the conductive hollow fiber tubes. Compared with a conventional AEM electrolytic cell, the electrolytic cell provided by the present invention can produce hydrogen with lower mass transfer resistance and lower energy consumption.

### BACKGROUND OF THE INVENTION

Hydrogen is an important source of green energy because the combustion of hydrogen produces water and does not emit greenhouse gases such as carbon dioxide. Hydrogen production by water electrolysis is an effective source of hydrogen. In the future, together with solar and wind power, it will be an important hydrogen production solution for obtaining clean green hydrogen.

The principle of water electrolysis to produce hydrogen is that the anode, the cathode, and the water or electrolyte in the electrolysis tank form a loop to constitute an electrolytic cell. When an electric current is applied, water undergoes a redox reaction to produce hydrogen at the cathode and oxygen at the anode.

As shown in FIG. 10, anion exchange membrane electrolysis (AEM electrolysis) can use water or low-concentration electrolyte to electrolyze water to produce hydrogen. An AEM electrolysis cell includes an anion exchange membrane A between an anode B and a cathode C and an electrolysis tank D connected to the anode B. After the power supply is turned on, the water in the electrolysis tank D will flow to the anode B. The water molecules diffuse through the anion exchange membrane A and enter the cathode C and decompose to produce hydrogen and hydroxide ions. The hydroxide ions diffuse through the anion exchange membrane A and return to the anode B to produce oxygen. The oxygen flows back to the electrolysis tank D and is discharged through an exhaust valve. The diffusion of the water molecules and the hydroxide ions in the anion exchange membrane A is isotropic. Only the surface of the anion exchange membrane A serves as the mass transfer area.

According to experimental results, the AEM electrolysis cell requires approximately 50 KWh to 55 KWh of energy to produce 1 kg of hydrogen. The main reason for the high energy consumption mentioned above can be attributed to the small mass transfer area. Besides, when oxygen is produced, the oxygen bubbles will obstruct the contact between the anode and the electrolyte/water, resulting in a higher mass transfer resistance.

In addition, because the oxygen from the AEM electrolytic cell is bubbled at the anode/electrolyte interface and then returned to the electrolysis tank and discharged, it will mix with some water or electrolyte, resulting in higher alkalinity and moisture content of the discharged oxygen.

### SUMMARY OF THE INVENTION

In view of the foregoing problems, the primary object of the present invention is to provide an electrolytic cell and an anion-exchange conductive hollow fiber tube matrix thereof.

The anion-exchange conductive hollow fiber tube matrix comprises a plurality of conductive hollow fiber tubes arranged adjacent to each other in a matrix. The conductive hollow fiber tubes each have a diffusion surface and two opposite ends defined as an inlet and an outlet.

The electrolytic cell comprises the foregoing anion-exchange conductive hollow fiber tube matrix; an anode and a cathode, disposed adjacent to the diffusion surface; an electrolysis tank, being in communication with the inlet and the outlet; and a power supply, connected to the anode and the cathode.

When in operation, the power supply is turned on and water in the electrolysis tank flows into the conductive hollow fiber tubes from the inlet, water molecules enter the cathode from the diffusion surface and decompose to produce hydrogen and hydroxide ions, the hydrogen is discharged from the cathode, the hydroxide ions return to the conductive hollow fiber tubes from the diffusion surface and then enter the anode from the diffusion surface to produce oxygen, the oxygen is discharged from a surface of the anode, and the water is returned to the electrolysis tank through the outlet.

Preferably, the conductive hollow fiber tubes are treated with ammonium.

Preferably, a catalyst is provided between the anion-exchange conductive hollow fiber tube matrix and the anode as well as between the anion-exchange conductive hollow fiber tube matrix and the cathode. The catalyst is a nickel/iron alloy oxide. Preferably, the catalyst is coated on the diffusion surfaces of the conductive hollow fiber tubes.

Preferably, a conductive carbon fiber diffusion layer is provided between the anion-exchange conductive hollow fiber tube matrix and the anode as well as between the anion-exchange conductive hollow fiber tube matrix and the cathode.

Preferably, the electrolytic cell further comprises a non-electric photocatalytic hydrogen production mechanism. The non-electric photocatalytic hydrogen production mechanism includes a water supply tank, a first photocatalyst disposed in the water supply tank and connected to the anode, and a second photocatalyst disposed in the water supply tank and connected to the cathode. The first photocatalyst and the second photocatalyst produce the hydrogen near the cathode and the oxygen near the anode through a photoreaction.

Preferably, the electrolytic cell further comprises a non-electric chemical energy hydrogen production mechanism. The non-electric chemical energy hydrogen production mechanism includes a reaction tank. By introducing chemical agents into the reaction tank, the hydrogen is produced near the cathode, and the oxygen is produced near the anode.

Preferably, the conductive hollow fiber tubes each is manufactured by perforating a conductive film in a regular or irregular pattern.

According to the above technical features, the present invention can achieve the following effects:
1. In the electrolytic cell provided by the present invention, water or electrolyte is directly introduced into the anion-exchange conductive hollow fiber tube matrix, and oxygen is directly produced and discharged on the wet surface of the anode, without oxygen bubbles hindering the contact between the anode and the electrolyte or water, thereby reducing the mass transfer resistance and maintaining the effective area of the electrode. According to the experimental results, the electrolytic cell of the present invention requires only about 40 to 45 kWh of energy to produce 1 kilogram of hydrogen. In contrast, the conventional AEM electrolytic cell requires approximately 50 to 55 kWh of energy to produce 1 kilogram of hydrogen. The electrolytic cell of the present invention can produce hydrogen with lower energy consumption.
2. In the electrolytic cell provided by the present invention, the diffusion of the water molecules and the hydroxide ions in the anion-exchange conductive hollow fiber tube matrix is anisotropic. The anion-exchange conductive hollow fiber tube matrix has a large mass transfer area. (The wall of each conductive hollow fiber tube serves as a mass transfer surface.) Larger mass transfer area can provide better performance and lower power consumption.
3. When the electrolytic cell provided by the present invention electrolyzes water to produce hydrogen, the oxygen produced on the surface of the anode will not be mixed into water or the electrolyte but will be directly discharged from the surface of the anode, thereby achieving oxygen collection with lower alkalinity, lower water content, and higher pressure.
4. The electrolytic cell provided by the present invention may further comprise the non-electric photocatalytic hydrogen production mechanism or the non-electric chemical energy hydrogen production mechanism that can produce hydrogen stably and continuously in the absence of electricity.

### BRIEF DESCRIPTION OF THE DRAWINGS

FIG. 1 is a perspective view of the anion-exchange conductive hollow fiber tube matrix of the electrolytic cell of the present invention;

FIG. 2 is a schematic view of the electrolytic cell of the present invention;

FIG. 3 is a schematic view showing the diffusion of water or electrolyte flowing into the anion-exchange conductive hollow fiber tube matrix during hydrogen production by water electrolysis in the electrolytic cell of the present invention;

FIG. 4 is a graph showing the electrolysis voltage curves of the electrolytic cell of the present invention and the conventional AEM electrolytic cell during water electrolysis under the same current density;

FIG. 5 is a graph showing the electrolysis voltage curves of the electrolysis cell of the present invention and the conventional AEM electrolysis cell during water electrolysis under the same hydrogen production rate, the same number of cell stacks and the same current conditions;

FIG. 6 is a schematic view of the electrolytic cell of the present invention in which the catalyst and the conductive carbon fiber diffusion layer are provided between the anion-exchange conductive hollow fiber tube matrix and the anode/cathode;

FIG. 7A shows that the catalyst is coated on the inner and outer sides of the diffusion surface of the conductive hollow fiber tube;

FIG. 7B shows that the catalyst is coated on the outer side of the diffusion surface of the conductive hollow fiber tube;

FIG. 7C shows that the catalyst is coated on the inner side of the diffusion surface of the conductive hollow fiber tube;

FIG. 8 is a schematic view showing that the electrolytic cell further comprises the non-electric photocatalytic hydrogen production mechanism;

FIG. 9 is a schematic view showing that the electrolytic cell further comprises the non-electric chemical energy hydrogen production mechanism;

FIG. 10 is a schematic view of the conventional AEM electrolysis cell;

FIG. 11 is a schematic view of an embodiment of the present invention, wherein the conductive film is perforated with a series of consecutive holes arranged in a regular pattern of multiple straight strips to form the conductive hollow fiber tube;

FIG. 12 is a schematic view of another embodiment of the present invention, wherein the conductive film is perforated with a series of consecutive holes arranged in a regular pattern of multiple spirals to form the conductive hollow fiber tube;

FIG. 13 is a schematic view of a further embodiment of the present invention, wherein the conductive film is perforated with a series of consecutive holes arranged in an irregular pattern of multiple staggered straight strips to form the conductive hollow fiber tube; and

FIG. 14 is a schematic view of a yet further embodiment of the present invention, wherein the conductive film is perforated with a plurality of irregularly arranged holes of varying sizes to form the conductive hollow fiber tube.

### DETAILED DESCRIPTION OF THE PREFERRED EMBODIMENTS

Embodiments of the present invention will now be described, by way of example only, with reference to the accompanying drawings.

The present invention discloses an electrolytic cell and an anion-exchange conductive hollow fiber tube matrix thereof.

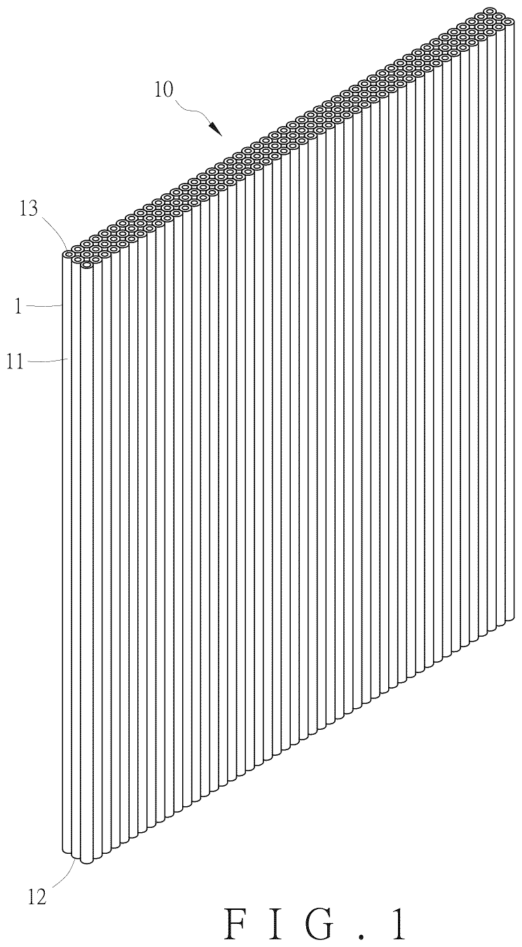

Referring to FIG. 1, the anion-exchange conductive hollow fiber tube matrix 10 according to an embodiment of the present invention comprises a plurality of conductive hollow fiber tubes 1 arranged adjacent to each other in a matrix. The conductive hollow fiber tube 1 has a diffusion surface 11 and two opposite ends defined as an inlet 12 and an outlet 13. The material of the conductive hollow fiber tube 1 is conductive carbon fiber. The anion-exchange conductive hollow fiber tube matrix 10 of this embodiment is composed of a plurality of conductive hollow fiber tubes 1 arranged into a film of 10 cm*10 cm, with a thickness of about 20 μm. The diameter of the flow channel inside the conductive hollow fiber tube 1 is about 5 μm to 15 μm. The conductive hollow fiber tube 1 is treated with ammonium, through which ammonium ion (NH4⁺) functional groups are formed on the polymer-based conductive hollow fiber tube 1. The ammonium ion functional groups allow hydroxide ions (OH⁻) , a key medium for water electrolysis, to pass through, thereby imparting anion-conducting properties.

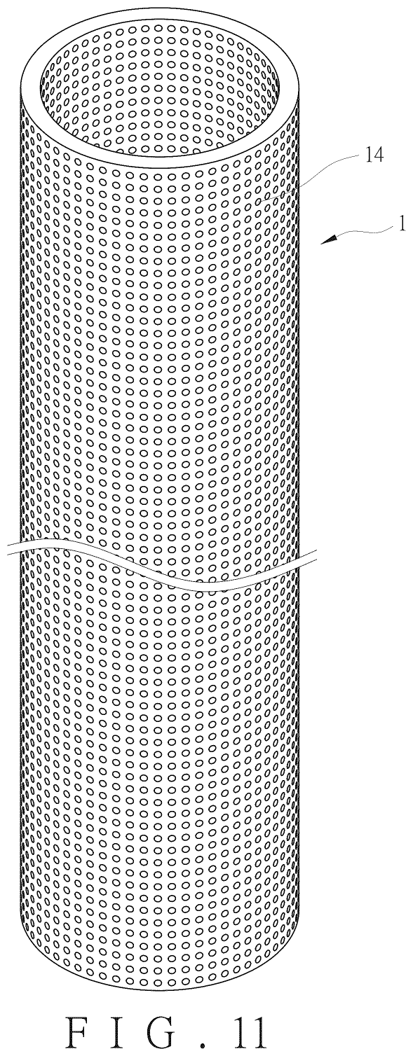

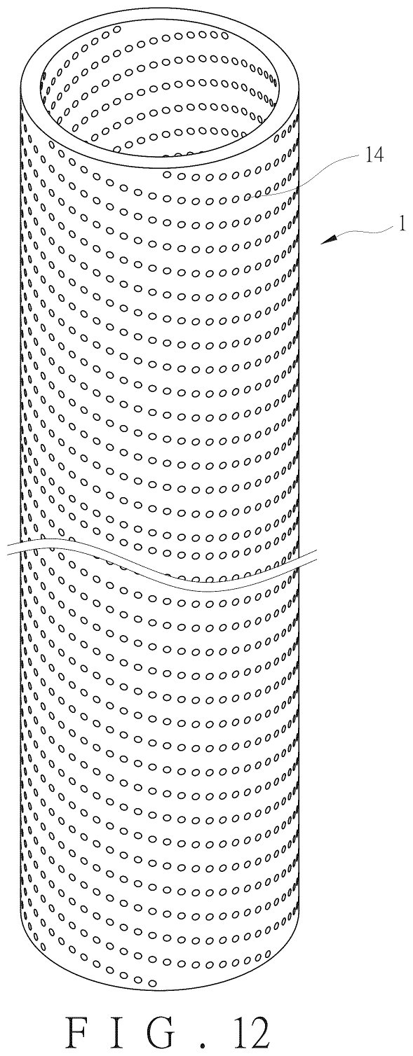

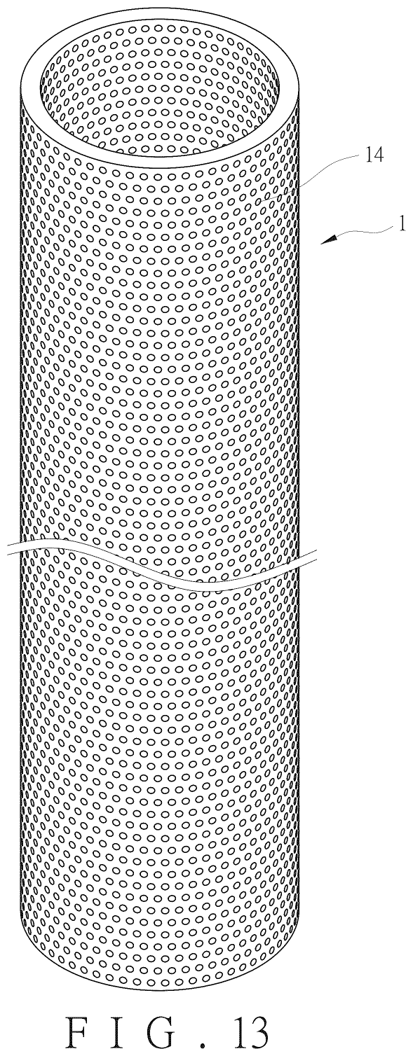

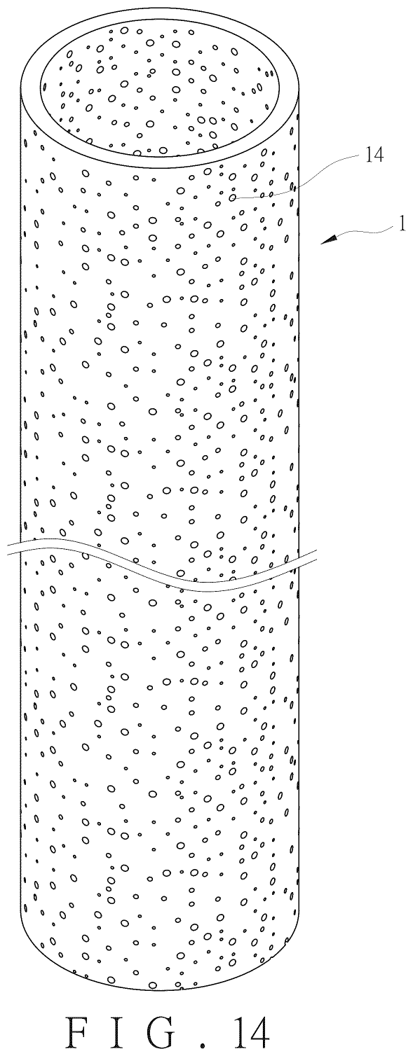

Referring to FIG. 11 through FIG. 14, in addition to arranging a plurality of individual conductive hollow fiber tubes 1 into the anion-exchange conductive hollow fiber tube matrix 10, the conductive hollow fiber tubes 1 are each manufactured by perforating a conductive film in a regular or irregular pattern and then arranged into the anion-exchange conductive hollow fiber tube matrix 10. For example, as shown in FIG. 11, a conductive film is perforated with a series of consecutive holes 14 arranged in a regular pattern of multiple straight strips to form the conductive hollow fiber tube 1; as shown in FIG. 12, a conductive film is perforated with a series of consecutive holes 14 arranged in a regular pattern of multiple spirals to form the conductive hollow fiber tube 1; as shown in FIG. 13, a conductive film is perforated with a series of consecutive holes 14 arranged in an irregular pattern of multiple staggered straight strips to form the conductive hollow fiber tube 1; as shown in FIG. 14, a conductive film is perforated with a plurality of irregularly arranged holes 14 of varying sizes to form the conductive hollow fiber tube 1.

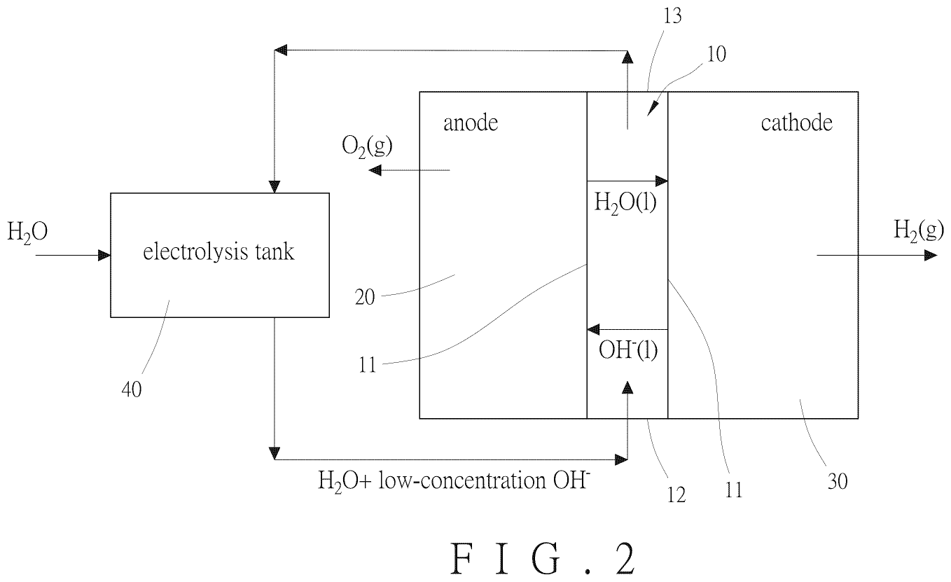

Referring to FIG. 2, the electrolytic cell of this embodiment comprises the anion-exchange conductive hollow fiber tube matrix 10, an anode 20, a cathode 30, an electrolysis tank 40, and a power supply. The anode 20 and the cathode 30 are disposed adjacent to the diffusion surface 11. Preferably, the anode 20 and the cathode 30 are disposed on opposite sides of the anion-exchange conductive hollow fiber tube matrix 10. In this embodiment, the anode 20 and the cathode 30 use nickel foam electrodes. The electrolysis tank 40 is in communication with the inlet 12 and the outlet 13. The power supply is connected to the anode 20 and the cathode 30. The connection of the power supply to the anode 20 and the cathode 30 is a known technique, so the power supply is not shown in the figure.

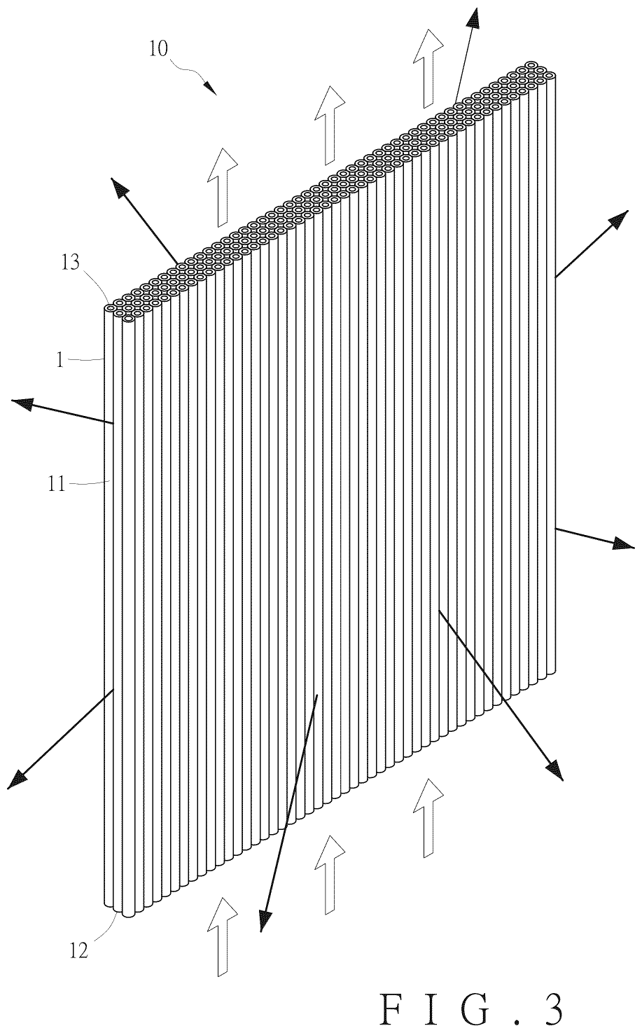

Referring to FIG. 2 and FIG. 3, when in operation, the power supply is turned on and the water in the electrolysis tank 40 flows into the conductive hollow fiber tube 1 from the inlet 12. Water molecules enter the cathode 30 from the diffusion surface 11 and decompose to produce hydrogen and hydroxide ions. The hydrogen is discharged from the cathode 30. The hydroxide ions return to the conductive hollow fiber tube 1 from the diffusion surface 11, and then enter the anode 20 from the diffusion surface 11 to produce oxygen. The oxygen is discharged directly from the surface of the anode 20 and the water is returned to the electrolysis tank 40 through the outlet 13. The diffusion of the water molecules and the hydroxide ions in the anion-exchange conductive hollow fiber tube matrix 10 is anisotropic. The anion-exchange conductive hollow fiber tube matrix 10 has a large mass transfer area. (The wall of each conductive hollow fiber tube 1 serves as a mass transfer surface.) Larger mass transfer area can provide better performance and lower power consumption. In the electrolytic cell provided by the present invention, water or electrolyte is directly introduced into the anion-exchange conductive hollow fiber tube matrix 10, and oxygen is directly produced and discharged on the wet surface of the anode 20, without oxygen bubbles hindering the contact between the anode 20 and the electrolyte or water, thereby reducing the mass transfer resistance, maintaining the effective area of the electrode, and improving the efficiency of the hydrogen production.

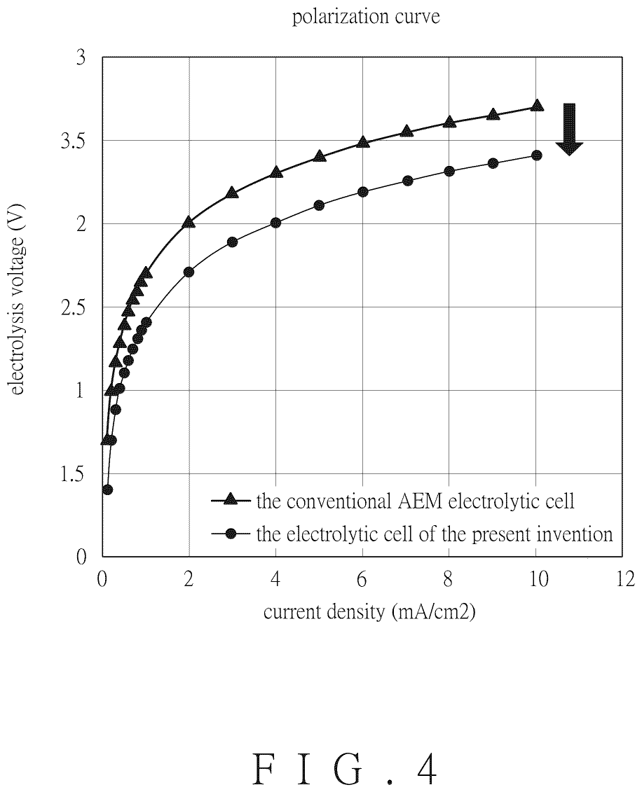

Referring to FIG. 4, due to the larger mass transfer area, the mass transfer resistance is reduced and the effective area of the electrode can be maintained. Under the same current density, the electrolytic cell of the present invention exhibits a lower electrolysis voltage compared with the conventional AEM electrolytic cell.

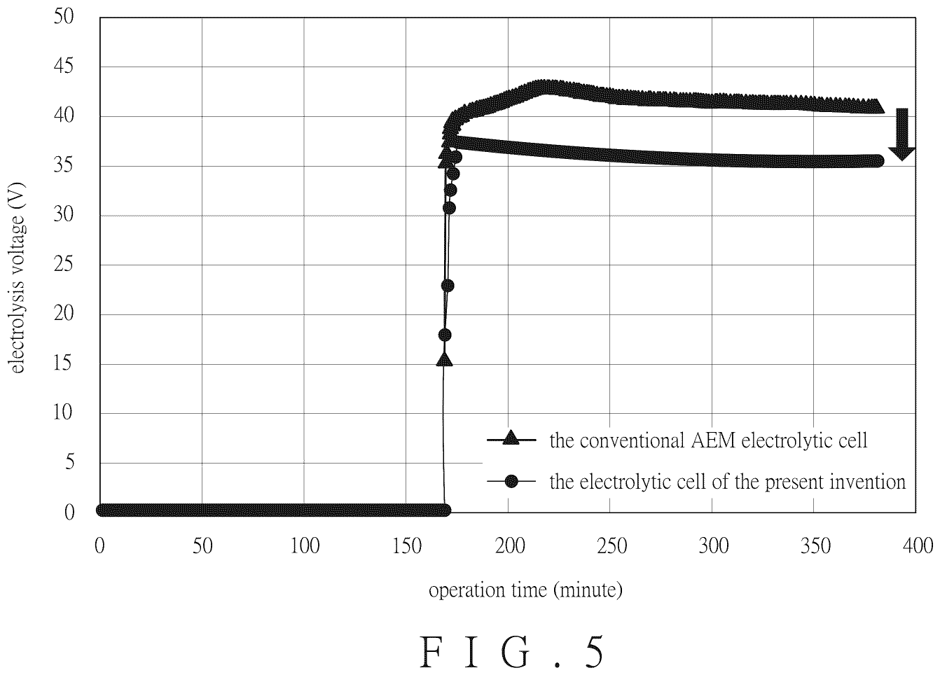

Referring to FIG. 5, when the electrolytic cell of the present invention and the conventional AEM electrolytic cell are operated continuously for 400 minutes under the same hydrogen production rate, the same number of cell stacks and the same current conditions, the electrolytic cell of the present invention exhibits a lower electrolysis voltage compared with the conventional AEM electrolytic cell.

According to the foregoing description and experimental results, the electrolytic cell of the present invention requires only about 40 to 45 kWh of energy to produce 1 kilogram of hydrogen. In contrast, the conventional AEM electrolytic cell requires approximately 50 to 55 kWh of energy to produce 1 kilogram of hydrogen. This demonstrates that the electrolytic cell provided by the present invention can produce hydrogen with lower energy consumption.

In addition, when the electrolytic cell provided by the present invention electrolyzes water to produce hydrogen, the oxygen produced on the surface of the anode 20 will not be mixed into water or the electrolyte but will be directly discharged from the surface of the anode 20, thereby achieving oxygen collection with lower alkalinity, lower water content, and higher pressure.

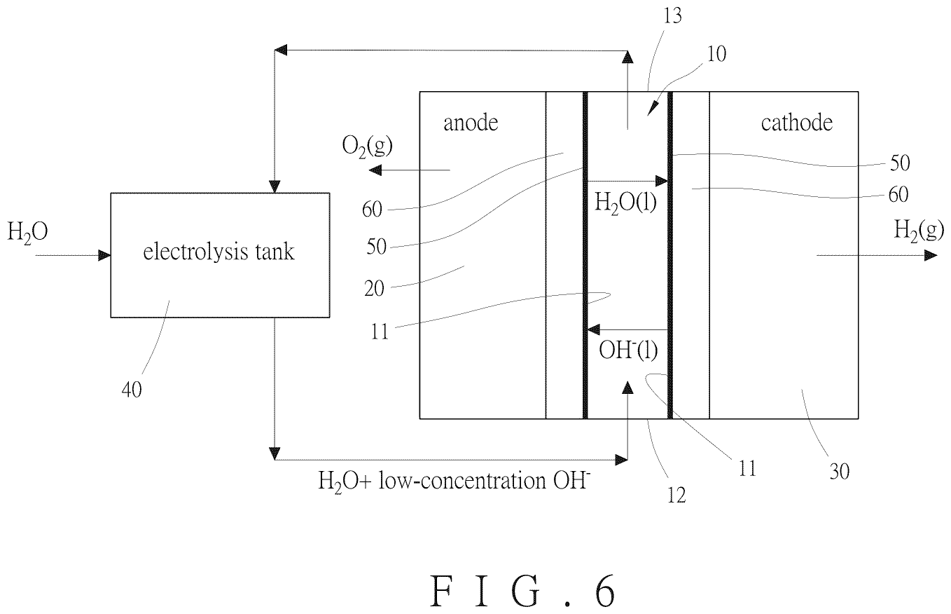

Referring to FIG. 6, for improving the ion diffusion efficiency, the electrolytic cell may further include a catalyst 50 and a conductive carbon fiber diffusion layer 60 between the anion-exchange conductive hollow fiber tube matrix 10 and the anode 20 as well as between the anion-exchange conductive hollow fiber tube matrix 10 and the cathode 30. Specifically, the catalyst 50 may be a nickel/iron alloy oxide, and the catalyst 50 may be in the form of a slurry and coated on the conductive carbon fiber diffusion layer 60. The conductive carbon fiber diffusion layer 60 is a porous carbon fiber material. The catalyst 50 can be adsorbed onto the surface of the conductive carbon fiber diffusion layer 60 and dried, such that the catalyst 50 and the conductive carbon fiber diffusion layer 60 form a film-like structure. The catalyst 50 can reduce the activation energy of water electrolysis in an alkaline environment, making it easier for water to decompose (dissociate) into hydrogen ions and hydroxide ions, and the hydroxide ions are easily oxidized to oxygen. Therefore, the catalyst 50 can reduce the energy consumption of water electrolysis and improve the production efficiency of hydrogen.

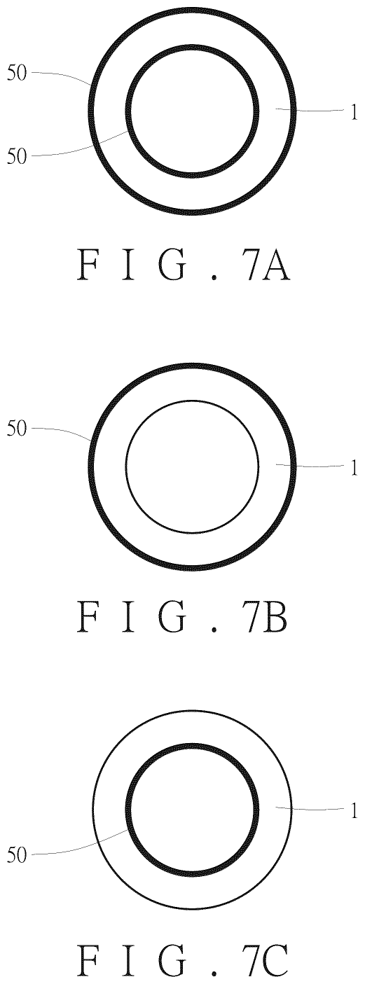

Referring to FIG. 7A through FIG. 7C, the catalyst 50 may be coated on the diffusion surface 11 of the conductive hollow fiber tube 1. As shown in FIG. 7A, the catalyst 50 is coated on the inner and outer sides of the diffusion surface 11 of the conductive hollow fiber tube 1. As shown in FIG. 7B, the catalyst 50 is coated on the outer side of the diffusion surface 11 of the conductive hollow fiber tube 1. As shown in FIG. 7C, the catalyst 50 is coated on the inner side of the diffusion surface 11 of the conductive hollow fiber tube 1. This can increase the specific surface area of the catalyst 50 for reaction, thereby improving the reaction efficiency.

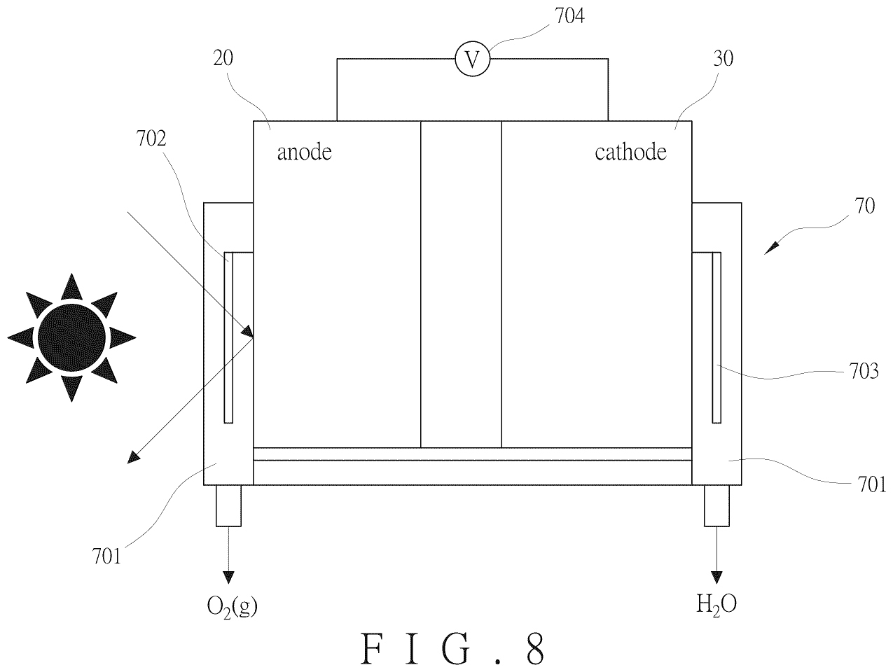

Referring to FIG. 8, the electrolytic cell may further comprise a non-electric photocatalytic hydrogen production mechanism 70. The non-electric photocatalytic hydrogen production mechanism 70 includes a water supply tank 701, a first photocatalyst 702 disposed in the water supply tank 701 and connected to the anode 20, a second photocatalyst 703 disposed in the water supply tank 701 and connected to the cathode 30, and a voltmeter 704 connected between the anode 20 and the cathode 30. The first photocatalyst 702 and the second photocatalyst 703 produce hydrogen near the cathode 30 and oxygen near the anode 20 through a photoreaction, and the voltage value can be read by the voltmeter 704. The non-electric photocatalytic hydrogen production mechanism 70 can produce hydrogen stably and continuously in the absence of electricity.

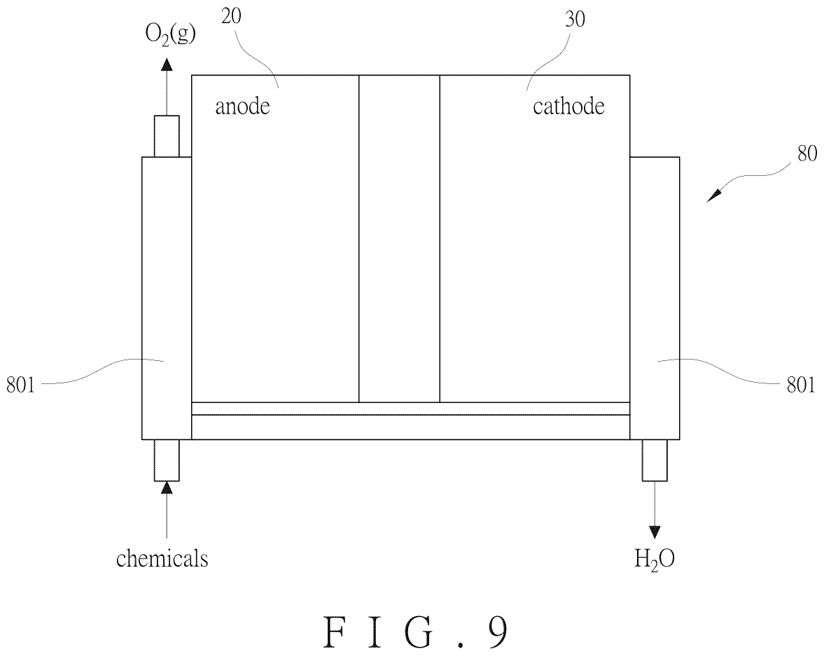

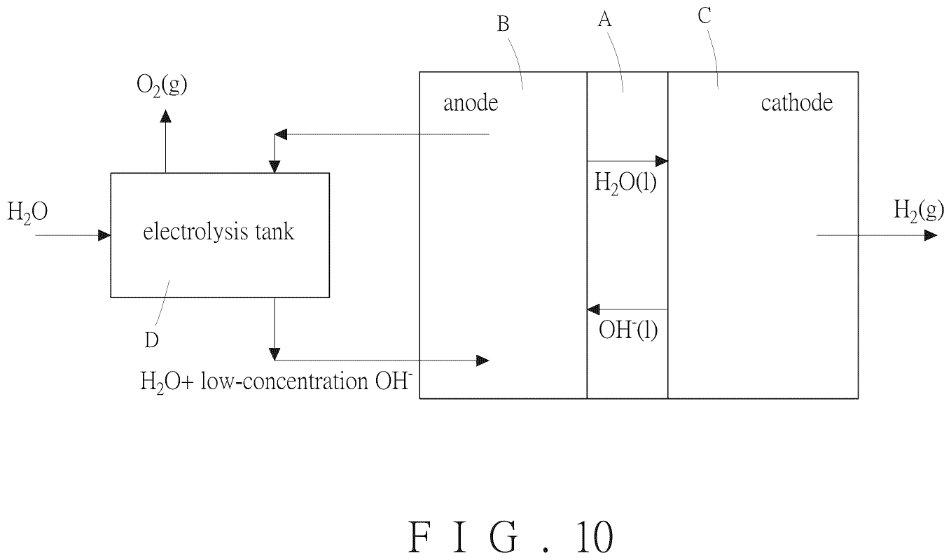

Referring to FIG. 9, the electrolytic cell may further comprise a non-electric chemical energy hydrogen production mechanism 80. The non-electric chemical energy hydrogen production mechanism 80 includes a reaction tank 801. By introducing chemical agents into the reaction tank 801, such as using an acidic solution or an alkaline solution to react with an alkali metal or an alkaline earth metal, hydrogen is produced near the cathode 30, and oxygen is produced near the anode 20. The non-electric chemical energy hydrogen production mechanism 80 can produce hydrogen stably and continuously in the absence of electricity.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An anion-exchange conductive hollow fiber tube matrix for an electrolytic cell, comprising:
a plurality of conductive hollow fiber tubes arranged adjacent to each other in a matrix, the conductive hollow fiber tubes each having a diffusion surface and two opposite ends defined as an inlet and an outlet,
wherein when in operation, an anode and a cathode of an electrolytic cell are disposed adjacent to the diffusion surface, an electrolysis tank of the electrolytic cell is in communication with the inlet and the outlet, and a power supply is connected to the anode and the cathode; the power supply is turned on and water in the electrolysis tank flows into the conductive hollow fiber tubes from the inlet, water molecules enter the cathode from the diffusion surface and decompose to produce hydrogen and hydroxide ions, the hydrogen is discharged from the cathode, the hydroxide ions return to the conductive hollow fiber tubes from the diffusion surface and then enter the anode from the diffusion surface to produce oxygen, the oxygen is discharged from a surface of the anode, and the water is returned to the electrolysis tank through the outlet.

2. The anion-exchange conductive hollow fiber tube matrix as claimed in claim 1, wherein the conductive hollow fiber tubes are treated with ammonium.

3. The anion-exchange conductive hollow fiber tube matrix as claimed in claim 1, wherein a catalyst is coated on the diffusion surfaces of the conductive hollow fiber tubes.

4. The anion-exchange conductive hollow fiber tube matrix as claimed in claim 3, wherein the catalyst is a nickel/iron alloy oxide.

5. The anion-exchange conductive hollow fiber tube matrix as claimed in claim 1, wherein the conductive hollow fiber tubes each is manufactured by perforating a conductive film in a regular or irregular pattern.

6. An electrolytic cell, comprising:
an anion-exchange conductive hollow fiber tube matrix, including a plurality of conductive hollow fiber tubes arranged adjacent to each other in a matrix, the conductive hollow fiber tubes each having a diffusion surface and two opposite ends defined as an inlet and an outlet;
an anode and a cathode, disposed adjacent to the diffusion surface;
an electrolysis tank, being in communication with the inlet and the outlet; and
a power supply, connected to the anode and the cathode,
wherein when in operation, the power supply is turned on and water in the electrolysis tank flows into the conductive hollow fiber tubes from the inlet, water molecules enter the cathode from the diffusion surface and decompose to produce hydrogen and hydroxide ions, the hydrogen is discharged from the cathode, the hydroxide ions return to the conductive hollow fiber tubes from the diffusion surface and then enter the anode from the diffusion surface to produce oxygen, the oxygen is discharged from a surface of the anode, and the water is returned to the electrolysis tank through the outlet.

7. The electrolytic cell as claimed in claim 6, wherein the conductive hollow fiber tubes are treated with ammonium.

8. The electrolytic cell as claimed in claim 6, wherein a catalyst is provided between the anion-exchange conductive hollow fiber tube matrix and the anode as well as between the anion-exchange conductive hollow fiber tube matrix and the cathode.

9. The electrolytic cell as claimed in claim 8, wherein the catalyst is coated on the diffusion surfaces of the conductive hollow fiber tubes.

10. The electrolytic cell as claimed in claim 8, wherein the catalyst is a nickel/iron alloy oxide.

11. The electrolytic cell as claimed in claim 6, wherein a conductive carbon fiber diffusion layer is provided between the anion-exchange conductive hollow fiber tube matrix and the anode as well as between the anion-exchange conductive hollow fiber tube matrix and the cathode.

12. The electrolytic cell as claimed in claim 6, further comprising a non-electric photocatalytic hydrogen production mechanism, the non-electric photocatalytic hydrogen production mechanism including a water supply tank, a first photocatalyst disposed in the water supply tank and connected to the anode, and a second photocatalyst disposed in the water supply tank and connected to the cathode, the first photocatalyst and the second photocatalyst producing the hydrogen near the cathode and the oxygen near the anode through a photoreaction.

13. The electrolytic cell as claimed in claim 6, further comprising a non-electric chemical energy hydrogen production mechanism, the non-electric chemical energy hydrogen production mechanism including a reaction tank, by introducing chemical agents into the reaction tank, the hydrogen being produced near the cathode, and the oxygen being produced near the anode.

14. The electrolytic cell as claimed in claim 6, wherein the conductive hollow fiber tubes each is manufactured by perforating a conductive film in a regular or irregular pattern.
